(19) United States
(12) Patent Application Publication
(10) Pub. No.: US 2026/0065938 A1
(43) Pub. Date: Mar. 5, 2026

(54) METHOD AND APPARATUS FOR VIDEO EDITING BASED ON DRAG AND INPUT/OUTPUT REGION

(71) Applicant: Electronics and Telecommunications Research Institute, Daejeon (KR)

(72) Inventors: Ji Wan KIM, Daejeon (KR); Do Hyung KIM, Daejeon (KR)

(73) Assignee: Electronics and Telecommunications Research Institute, Daejeon (KR)

(21) Appl. No.: 19/023,851

(22) Filed: Jan. 16, 2025

(30) Foreign Application Priority Data
Aug. 27, 2024 (KR) 10-2024-0114921
Dec. 31, 2024 (KR) 10-2024-0202114

(51) Int. Cl. G11B 27/022; G06F 3/04845

(52) U.S. Cl. CPC G11B 27/022; G06F 3/04845

(57) ABSTRACT

A method for video editing based on drag and an input/output region, comprising the steps of: receiving a handle point, a target point, a correction region including the handle point and the target point, and an output region, the output region being shape information desired to be generated using the video editing, from an original video; and generating an initial corrected video using a diffusion model, based on the handle point, the target point, the correction region, and the output region.

### CROSS-REFERENCE TO RELATED APPLICATION

This application claims the benefit of and priority to Korean Patent Application No. 10-2024-0114921, filed on Aug. 27, 2024, the entire disclosure(s) of which is hereby incorporated herein by reference in its entirety.

### TECHNICAL FIELD

The present disclosure relates to a method and apparatus for video editing based on drag and an input/output region.

### BACKGROUND

The content to be described below merely provides background information related to the present embodiment and does not constitute the related art.

With the development of artificial intelligence (AI) technology, innovative change occurs in the field of video editing. Initial AI-based video editing technology is mainly limited to automated editing, filter application, or the like, but with the recent development of a deep learning model, a more sophisticated and complex editing task has become possible.

A diffusion model, one of deep learning models, is a deep learning model that generates a high-quality image using denoising, and is recently applied to video editing. A prompt-based scheme is a scheme in which a user inputs text or specific instructions so that a video is edited according to the instructions. On the other hand, a point-based scheme allows a specific region or point of a video to be selected and editing to be performed based on the selected region. A sub-concept of the point-based scheme is a drag-based scheme. This refers to a scheme in which a user drags and edits an image using an input device such as a mouse or touch screen.

In a drag-based video editing scheme, if a handle point, a target point, and a region to be corrected are input, a corrected video is naturally generated when a handle point in a selected region of an original video moves to a target point. The drag-based scheme has the advantage of obtaining an edited video while preserving features of an original video well compared to other input schemes. However, the drag-based scheme also has disadvantages. Since the drag-based scheme is optimized for change in position between input points, editing results are not consistent and there are many cases in which distortion is severe in some regions due to limitations of learning data of a diffusion model.

### SUMMARY

An object of the present disclosure is to provide a method and apparatus for specifying a shape desired to be created using video editing in order to solve a problem that editing results are not consistent since a mouse drag-based video editing scheme of the related art is optimized for change in position between input points.

Another object of the present disclosure is to provide a method and apparatus for creating a natural edited video by correcting a distorted region caused by limitations of learning data of a diffusion model.

The problems to be solved by the present disclosure are not limited to the problems described above, and other problems that are not described can be clearly understood by those skilled in the art from the description below.

Only a handle point, a target point, and a correction region to be corrected are received in a mouse drag-based video editing scheme, whereas, according to an embodiment of the present disclosure, it is possible for a user to clearly specify a shape to be corrected by additionally receiving shape information desired to be generated using video editing.

According to an embodiment of the present disclosure, it is possible to acquire a high-quality edited video by correcting a distorted region generated in a video editing process using information of an original video.

The effects of the present disclosure are not limited to the effects described above, and other effects not described will be clearly understood by those skilled in the art from the description below.

### BRIEF DESCRIPTION OF THE DRAWINGS

FIG. 1 is a block diagram illustrating a method for video editing based on drag and an input/output region according to an embodiment of the present disclosure.

FIG. 2 is an illustrative diagram illustrating a method for video editing based on drag and an input/output region according to an embodiment of the present disclosure.

FIG. 3 is a block diagram schematically illustrating an apparatus for video editing based on drag and an input/output region according to an embodiment of the present disclosure.

FIG. 4 is an illustrative diagram illustrating the method for video editing based on drag and the input/output region according to an embodiment of the present disclosure.

FIG. 5 is an illustrative diagram illustrating a distorted region generated from an initial corrected video according to an embodiment of the present disclosure.

FIG. 6 is an illustrative diagram illustrating a mask operation that is performed in an initial distortion correction process according to an embodiment of the present disclosure.

FIG. 7 is an illustrative diagram illustrating all distorted regions, and results of initial distortion correction and additional distortion correction according to an embodiment of the present disclosure.

FIG. 8 is an illustrative diagram illustrating a reference-based deformation scheme according to an embodiment of the present disclosure.

FIG. 9 is a flowchart schematically illustrating a method for video editing based on drag and an input/output region according to an embodiment of the present disclosure.

FIG. 10 is a diagram schematically illustrating a configuration of an exemplary computing device that can be used to implement the apparatuses and methods described in the present disclosure.

### DETAILED DESCRIPTION

Hereinafter, the term “image” may be a still video or may be a frame of a video.

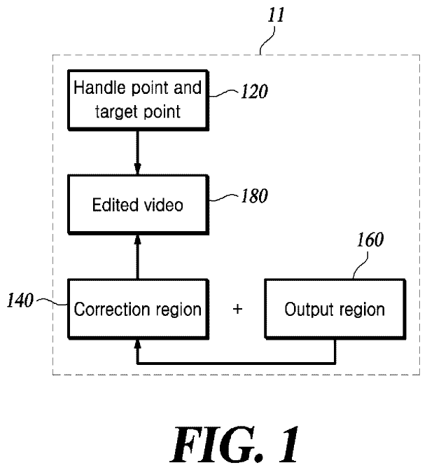

FIG. 1 is a block diagram illustrating a method for video editing based on drag and an input/output region according to an embodiment of the present disclosure.

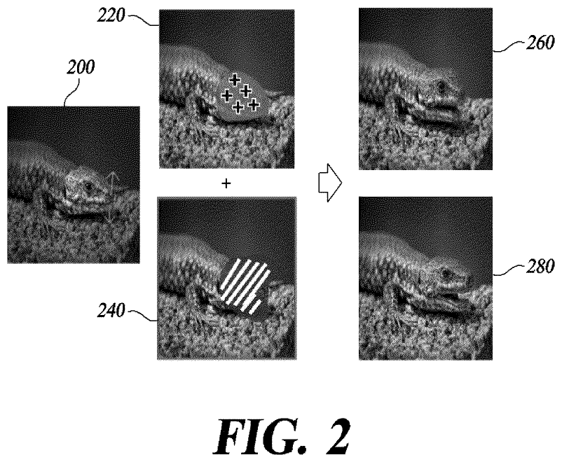

FIG. 2 is an illustrative diagram illustrating a method for video editing based on drag and an input/output region according to an embodiment of the present disclosure.

When the apparatus for video editing based on drag and an input/output region 11 receives a handle point and a target point, and a correction region 140 to be corrected, which includes the handle point and the target point, from an original video, the apparatus for video editing based on drag and an input/output region 11 tracks a movement path of the point based on a position information of the correction region to edit a video.

The handle point and the target point can be said to be points that are visually indicated to move a specific element of an object. The handle point indicates an initial position of the specific element of the object to be corrected, and the target point indicates a position after the movement is completed. For example, when video editing is performed to correct a closed snout of a lizard in FIG. 2 into an open one, handle points may be displayed on a maxilla and a mandible of the snout and target points may be displayed in a vertical outward direction from the respective handle points. In the case of FIG. 2, the handle points and target points are indicated using arrows so that the points can be distinguished (200).

The reason for indicating the correction region is to clearly define a region in which a specific deformation will occur in a process in which the diffusion model generates a video, and to limit a range of deformation.

An output region 160, which is shape information that the user desires to acquire, is additionally input. The output region 160 means the shape information that the user desires to generate using video editing. When the output region is input, the correction region focuses on pixel information of the output region so that the user can perform the correction more precisely as desired.

The correction region 220 and the output region 240 can be displayed using a method such as a mask. The mask helps select a specific portion from an image or video and perform an editing task on only the selected portion. Since the snout of the lizard to be corrected in FIG. 2 is located within a face, the correction region 220 may mask a portion of the lizard's face that includes the snout to be corrected. The correction region 220 is indicated by a cross pattern (+) on a translucent background. The output region 240 is indicated by a diagonal line ( [symbol] ) on a translucent background.

When the user only displays the correction region 220 without displaying the output region 240, a corrected video obtained by the diffusion model randomly transforming the snout of the lizard in a direction of movement of a handle point and target point 120 within the correction region 220 will be generated (260) and, when the output region 240 is input, a more precise corrected video may be generated as desired by the user (280).

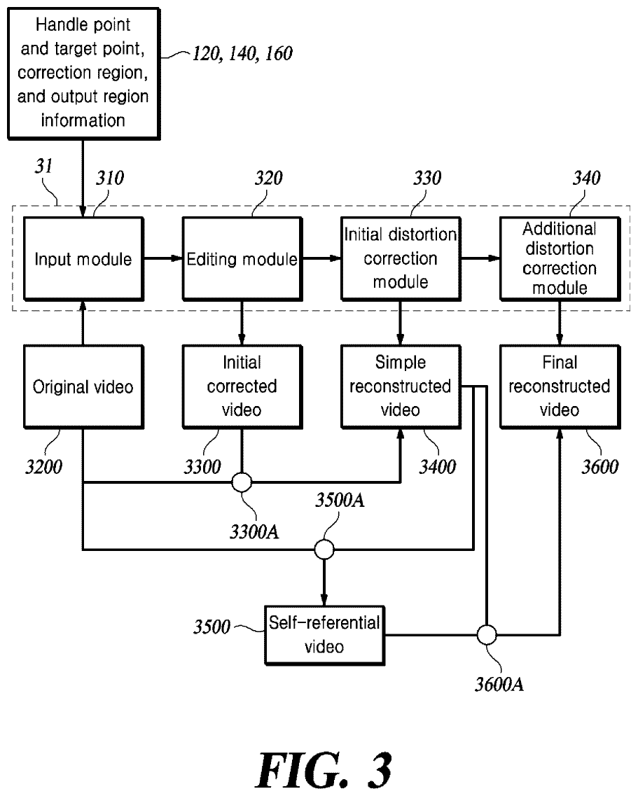

FIG. 3 is a block diagram schematically illustrating an apparatus for video editing based on drag and an input/output region according to an embodiment of the present disclosure.

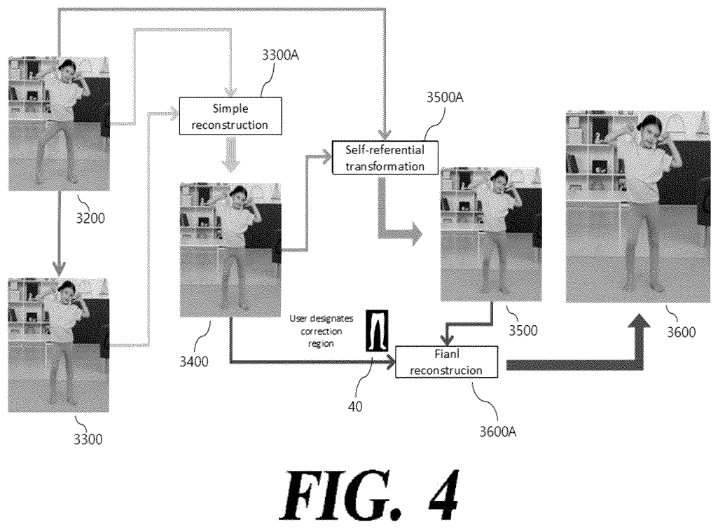

FIG. 4 is an illustrative diagram illustrating the method for video editing based on drag and an input/output region according to the embodiment of the present disclosure.

The apparatus for video editing based on drag and an input/output region 31 is an apparatus including an input module 310, an editing module 320, an initial distortion correction module 330, and an additional distortion correction module 340. The respective components represent functionally distinct elements, and at least one component may be implemented in a form in which the components are integrated with each other in an actual physical environment.

The input module 310 may receive an input for displaying a point or mask in a video using an input device such as a mouse or a touch screen. In general, a handle point and a target point may be displayed in the form of dots. In general, a mask region is displayed in a translucent color. The user may manipulate a size and position of the mask by using the input device, for example, in a drag-and-drop manner. The input device is not limited to the example above.

The editing module 320 generates an edited video based on information input to the input module 310. In this case, a diffusion model that is a generative artificial intelligence may be used. The diffusion model learns a distribution of data through a process of creating complete noise by gradually adding noise from data and a converse process of restoring the data by gradually removing the noise.

An objective function

$$L ( {\hat{z}}_{t}^{k} )$$

of the model used in the embodiment of the present disclosure is as shown in Formula 1.

$$L ( {\hat{z}}_{t}^{k} ) = {\sum }_{\text{?}}^{\text{?}} {\sum }_{\text{?}} {‖ {F}_{\text{?}} ( {\text{?}}_{\text{?}}^{\text{?}} ) - sg ( {F}_{\text{?}} ( {\text{?}}_{\text{?}}^{\text{?}} ) ) ‖}_{1} + {λ}_{\text{?}} {‖ ( {\text{?}}_{\text{?}}^{\text{?}} - sg ( {\text{?}}_{\text{?}}^{\text{?}} ) ) ⊙ ( 1 - {\text{?}}_{\text{?}} ) ‖}_{1} + {λ}_{2} {\sum }_{\text{?}} ( {min}_{\text{?}} {\sum }_{\text{?}} \vert sg ( {F}_{\text{?}} ( {\text{?}}_{\text{?}} ) ) - {F}_{\text{?}} ( {\text{?}}_{\text{?}}^{\text{?}} ) \vert ) \qquad [ Formula 1 ]$$

$$\text{?} \text{indicates text missing or illegible when filed}$$

An i-th end point input by the user is gᵢ and a k-th updated point of the start point is hᵢ^{k}. In this case, a normal direction vector from the start point to the end point is

$${d}_{i} = ( {g}_{i} - {h}_{\text{?}}^{k} ) / {‖ {g}_{\text{?}} - {h}_{\text{?}}^{k} ‖}_{2} .$$

$$\text{?} \text{indicates text missing or illegible when filed}$$

A first term on the right side is an item for applying a penalty so that a difference between features of latent vectors

$${F}_{q + {d}_{i}} ( {\hat{z}}_{t}^{k} )$$

in a

$$q ∈ Ω ( {h}_{\text{?}}^{i} , {r}_{1} )$$

$$\text{?} \text{indicates text missing or illegible when filed}$$

region around the point and an original portion

$${F}_{q} ( {\hat{z}}_{t}^{k} )$$

is small while the start point moves k times. As a result, a difference in distribution of surrounding features is minimized when the hand point moves toward the target point. A latent vector is a vector for representing input data in a low-dimensional space, and plays a role in compressing important features of the data. In a deep learning model, each data point is represented as a feature vector. Applying a penalty so that the difference in feature is small means designing to have similar features.

A second term on the right side allows a portion 1-M other than a mask to follow a feature

$${\hat{z}}_{t - 1}^{0}$$

before updating when a correction region designated by the user is M. Mᵤₙ in the second term is defined as a union of the output region and the correction region rather than the previously input correction region M. As a result, a portion not included in the mask is not considered in a loss function. M is a binary mask, which is a method of displaying a pixel value of an image as 0 or 1 and as a selected region and an unselected region.

A third term on the right side is a sum of values for minimizing a difference between a k-th latent feature point

$${F}_{\text{?}} ( {{z}^{\text{?}}}_{t}^{k} )$$

$$\text{?} \text{indicates text missing or illegible when filed}$$

of a point pₜ in a target mask Mₜ and an initial latent feature

$${F}_{\text{?}} ( {{z}^{\text{?}}}_{t}^{k} )$$

$$\text{?} \text{indicates text missing or illegible when filed}$$

for a point pᵢ in an input mask Mᵢ. This is intended to minimize a difference in feature between the input mask and the output mask. In summary, the output region is additionally input so that approximate shape information that the user desires to acquire is provided. This is intended to apply a penalty so that a difference in feature between the correction region and the output region is small.

The initial distortion correction module 330 corrects a distorted region that has occurred in an initial corrected video 3300. Due to limitations of learning data of the diffusion model, distortion may occur in the video depending on scales of the edited video. For example, when a learning dataset is limited to a specific type of video or a specific scale (size, resolution, or the like) or lacks diversity, the model cannot generate an appropriate corrected video for a video of a new situation or various scales.

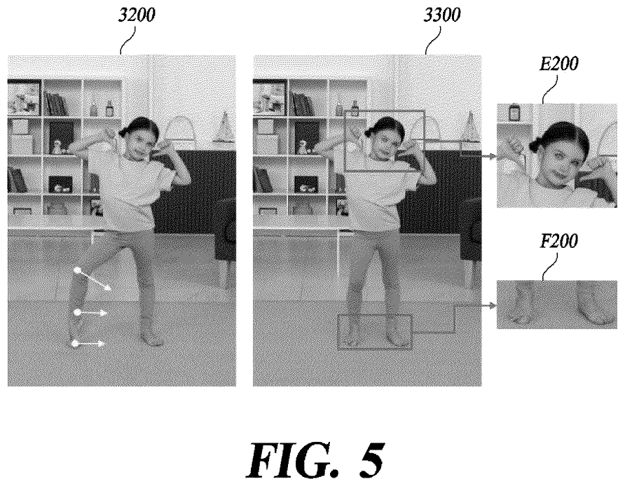

FIG. 5 is an illustrative diagram illustrating a distorted region generated from an initial corrected video according to an embodiment of the present disclosure.

It can be seen that distortion has occurred in eyes E200 and feet F200 of an object in the initial corrected video 3300 of FIG. 5. Here, the eyes E200 are portions outside the correction region, and the feet F200 are portions inside the correction region. When the diffusion model corrects a specific portion at the time of editing an image, the diffusion model tries to maintain the consistency of the entire image rather than independently processing only the portion. Therefore, even when only a leg portion is corrected from the original video 3200, the eye portions E200 of the face may be unintentionally distorted in a process of adjusting other portions of the image to achieve overall balance.

The eyes E200, which are distorted regions that have occurred in a portion other than the correction region in the initial corrected video 3300 may be replaced with the eye E100 of the original video, which is a corresponding region of the original video 3200. This may be performed using a mask operation 3300A.

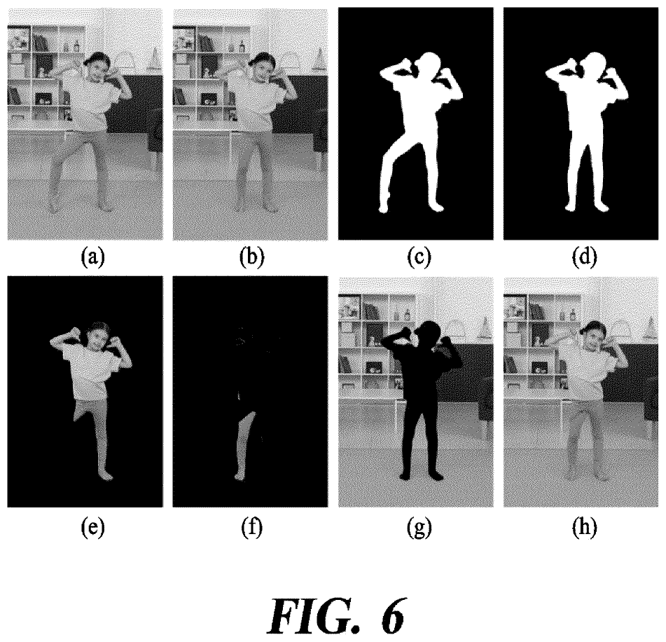

FIG. 6 is an illustrative diagram illustrating a mask operation that is performed in an initial distortion correction process according to an embodiment of the present disclosure.

The mask operation is a technology for selecting a specific region in an image and

performing a specific operation on the selected region on a pixel basis. The region selection is performed in the same way as a binary mask. In the case of multiplication ⊙, 1 is returned in a portion in which both masks are 1, and 0 is returned in a remaining region. Subtraction is used when another mask region is excluded from one mask.

A simple reconstructed video 3400 is a video created as a result of performing initial distortion correction using the mask operation 3300A. The mask operation 3300A is calculated as follows.

(a) of FIG. 6 is a diagram illustrating an original video, (b) of FIG. 6 is a diagram illustrating an initial corrected video, (c) of FIG. 6 is a diagram illustrating a mask of an object in the original video, and (d) of FIG. 6 is a diagram illustrating an example of a mask of an object in the initial corrected video.

The initial distortion correction module 330 selects a mask ((c) of FIG. 6) of the object in the original video 3200 ((a) of FIG. 6) and a mask ((d) of FIG. 6) of the object in the initial corrected video 3300 ((b) of FIG. 6).

$$min ( 1 - ( {M}_{d} - {M}_{o} ) , {I}_{o} ⊙ {M}_{d} ) \qquad [ Formula 2 ]$$

Formula 2 is a formula for generating a result of applying a region in which the mask ((c) of FIG. 6) of the object in the original video has been removed from the mask ((d) of FIG. 6) of the object in the initial corrected video, to the original video 3200. A result of Formula 2 is illustrated in (e) of FIG. 6.

Iₒ is the original video ((a) of FIG. 6), Mₒ is the mask of the object in the original video ((c) of FIG. 6), and Ma is the mask of the object in the initial corrected video ((d) of FIG. 6). The purpose of brightness adjustment is to obtain a difference M_{d}-Mₒ from 1.

$${I}_{d} ⊙ ( {M}_{d} - {M}_{o} ) \qquad [ Formula 3 ]$$

Formula 3 is applied by multiplying a region in which the mask ((c) of FIG. 6) of the object in the original video is removed from the initial corrected video ((b) of FIG. 6) and the mask ((d) of FIG. 6) of the object in the initial corrected video. In this process, only the mask ((d) of FIG. 6) of the object in the initial corrected video other than the mask ((c) of FIG. 6) of the object in the original video is left.

I_{d} is the initial corrected video ((b) of FIG. 6).

$$max ( {I}_{o} , {M}_{d} ) - {M}_{d} \qquad [ Formula 4 ]$$

Formula 4 represents a task of calculating a maximum value in the original video ((a) of FIG. 6) and the mask ((d) of FIG. 6) of the object in the initial corrected video, and then removing the mask ((d) of FIG. 6) of the object in the initial corrected video. In this process, the mask ((d) of FIG. 6) region of the object in the initial corrected video is removed, and other regions are emphasized.

Iₙ=Formula2+Formula3+Formula 4 [Formula 5]

In Formula 5, the results of Formulas 2, 3, and 4 are finally added to generate a final image. In this process, respective operations are combined so that a combination between the mask and the video is obtained.

Iₙ is the simple reconstructed video 3400 (3400; (h) of FIG. 6).

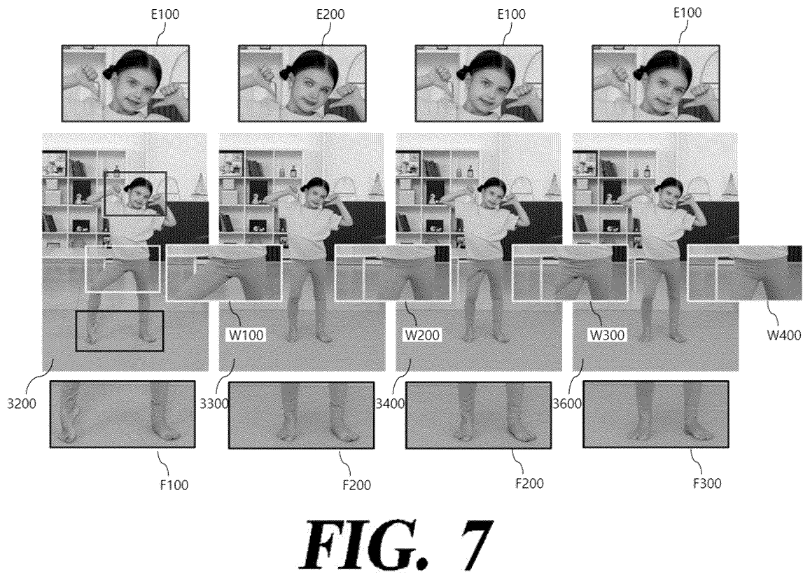

FIG. 7 is an illustrative diagram illustrating all distorted regions, and results of initial distortion correction and additional distortion correction according to an embodiment of the present disclosure.

It can be confirmed from the simple reconstructed video 3400 that the distorted region of the eye has been corrected (E200→E100). However, it can be confirmed from the initial corrected video 3300 that the foot portion F200 that is the distorted region occurring in the portion other than the correction region remains, and a newly occurring distorted region W300 within the correction region of the simple reconstructed video can also be confirmed. All remaining distorted regions are corrected through additional distortion correction.

The additional distortion correction module 340 performs additional distortion correction for correcting a remaining distorted region after the initial distortion correction. Since correction of the portion other than the correction region is performed by using the initial distortion correction module 330, the additional distortion correction is performed on the remaining distorted region within the correction region.

The distorted region remaining in the correction region is the region W300 that occurs and remains in the initial corrected video 3300 (F200) or is not naturally connected and is disconnected in the process of generating the simple reconstructed video 3400. When the additional distortion correction ends, a final reconstructed video 3600 is generated. The additional distortion correction is performed through self-referential transformation 3500A and mask operation 3600A.

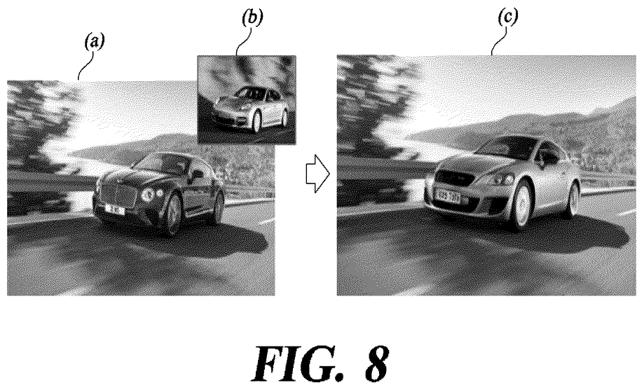

FIG. 8 is an illustrative diagram illustrating a reference-based deformation scheme according to an embodiment of the present disclosure.

The reference-based deformation scheme is a diffusion-based video generation technology for correcting a video to be corrected similarly to a reference video, and generates a video for maximizing a similarity between a correction region in the video to be corrected and a corresponding region in the reference video by selecting the two regions. For example, (a) of FIG. 8 illustrates an original image, (c) of FIG. 8 illustrates a corrected image, and (b) of FIG. 8 illustrates a reference image. A similarity between a blue car that is an object in (a) of FIG. 8 and a gray car that is an object in a corresponding region in (b) of FIG. 8 is maximized to generate the video in (c) of FIG. 8.

In an embodiment of the present disclosure, since the original video 3200 is used as a reference image, a video generated using the reference-based deformation scheme is called a self-referential video 3500.

The self-referential video 3500 is generated by maximizing a similarity between the simple reconstructed video 3400 and a corresponding correction region of the original video 3200 (3500A). In this process, the region W300 that occurs and remains in the initial corrected video 3300 (F200) or is not naturally connected and is disconnected in the process of generating the simple reconstructed video 3400 is subjected to distortion correction (W300, F200→W400, F300).

In the process of generating the self-referential video 3500, distortion may also occur in the portion other than the correction region. Therefore, the region corrected in the process of generating the self-referential video 3500 and a portion other than a portion 40 of the simple reconstructed video 3400 corresponding to the region corrected in the self-referential video 3500 are subjected to the mask operation to generate the final reconstructed video 3600 (3600A).

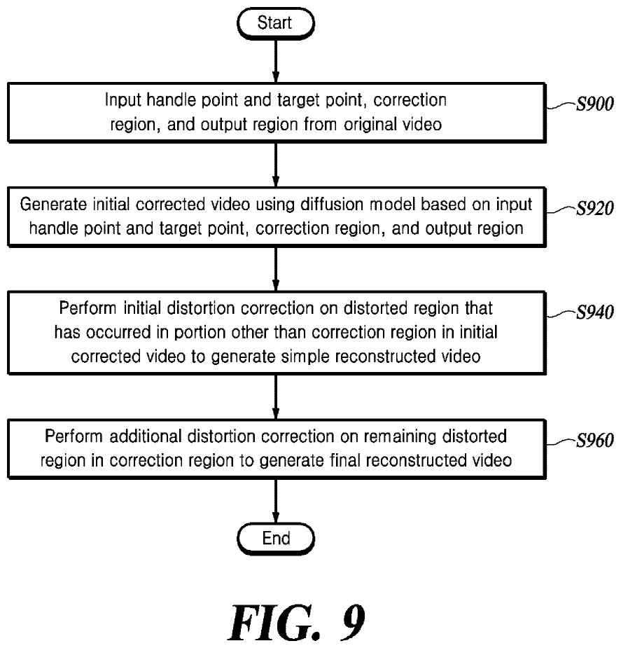

FIG. 9 is a flowchart schematically illustrating a method for video editing based on drag and an input/output region according to an embodiment of the present disclosure.

The apparatus for video editing based on drag and an input/output region 10 inputs the handle point and target point 120 that a user desires to correct in the original video 3200, the correction region 140 that includes the handle point and target point 120, which the user desires to correct, and the output region 160 that is shape information that the user desires to generate, as a video editing result (S900). Based on the input handle point and target point 120, the correction region 140, and the output region 160, the initial corrected video 3300 which is a correction result is generated using the diffusion model (S920).

The initial corrected video 3300 may have a distorted region occurring due to the limitations of the learning data of the diffusion model. A distorted region may occur in the portion other than the correction region. For example, a leg portion of a girl, which is an object in the video, was corrected, but distortion occurred in the eye portion, as illustrated in FIG. 5 (E200).

The distorted region that has occurred in the initial corrected video 3300 may be subjected to the initial distortion correction using the information of the original video 3200 (S940). For example, only a region in which distortion occurs is replaced with a corresponding region of the original video (E200→E100). In this case, a mask operation may be used. As a result, a simple reconstructed video 3400 is generated.

The additional distortion correction may be performed on the remaining distorted region F200 in the correction region of the initial corrected video 3300 after the initial distortion correction or the region W300 that is not naturally connected and is disconnected in a process of generating the simple reconstructed video 3400 (S960). The additional distortion correction may be performed by a reference-based deformation scheme and a mask operation. The reference-based deformation scheme is performed by selecting the correction region in the video to be corrected and the corresponding region in the original video 3200 and maximizing a similarity between the two regions (F200, W300→F300, W400). In an embodiment of the present disclosure, since the original video 3200 is referenced, a video generated using the reference-based deformation scheme is called the self-referential video 3500.

In the process of generating the self-referential video 3500, distortion may also occur in the portion other than the correction region. Therefore, the region corrected in the process of generating the self-referential video and a portion other than the portion 40 of the simple reconstructed video 3400 corresponding to the corrected region in the self-referential video 3500 are subjected to the mask operation (3600A) to generate the final reconstructed video 3600, and the video editing process ends (S960).

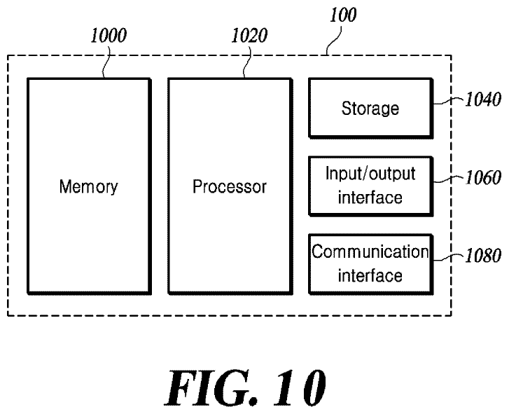

FIG. 10 is a diagram schematically illustrating a configuration of an exemplary computing device that can be used to implement the apparatuses and methods described in the present disclosure.

A computing device 100 may include some or all of a memory 1000, a processor 1020, a storage 1040, an input/output interface 1060, and a communication interface 1080. The computing device 100 may be a stationary computing device such as a desktop computer or a server, as well as a mobile computing device such as a laptop computer or a smartphone.

The computing device 100 may include any specialized hardware accelerator capable of efficiently processing operations for an artificial intelligence model. For example, the computing device 100 may include a graphic processing unit (GPU), a tensor processing unit (TPU), or a neural processing unit (NPU).

The memory 1000 may store a program that causes the processor 1020 to perform the methods or operations according to various embodiments of the present disclosure. For example, the program may include a plurality of instructions executable by the processor 1020, and the above-described methods or operations may be performed by the plurality of instructions being executed by the processor 1020. The memory 1000 may be a single memory or a plurality of memories. In this case, information necessary to perform the methods or operations according to various embodiments of the present disclosure may be stored in the single memory or may be divided and stored in the plurality of memories. When the memory 1000 includes the plurality of memories, the plurality of memories may be physically separated. The memory 1000 may include at least one of a volatile memory and a nonvolatile memory. The volatile memory may include a static random access memory (SRAM), a dynamic random access memory (DRAM), or the like, and the nonvolatile memory may include a flash memory, or the like.

The processor 1020 may include at least one core capable of executing at least one instruction. The processor 1020 may execute instructions stored in the memory 1000. The processor 1020 may be a single processor or a plurality of processors.

The storage 1040 maintains stored data even when power supplied to the computing device 100 is cut off. For example, the storage 1040 may include a nonvolatile memory, and may include storage media such as a magnetic tape, an optical disc, or a magnetic disk. A program stored in the storage 1040 may be loaded into the memory 1000 before being executed by the processor 1020. The storage 1040 may store a file created in a program language, and a program generated from the file by a compiler or the like may be loaded into the memory 1000. The storage 1040 may store data to be processed by the processor 1020 and/or data processed by the processor 1020.

The input/output interface 1060 can provide an interface with an input device such as a keyboard or a mouse and/or an output device such as a display device or a printer. A user can trigger the execution of the program in the processor 1020 through the input device and/or confirm processing results of the processor 1020 through the output device.

The communication interface 1080 can provide access to an external network. The computing device 100 can communicate with another device through the communication interface 1080.

At least some of the components described in the exemplary embodiments of the present disclosure may be implemented as hardware elements including at least one or a combination of a digital signal processor (DSP), a processor, a controller, an application-specific IC (ASIC), a programmable logic device (FPGA or the like), and other electronic devices. Further, at least some of functions or processes described in the exemplary embodiments may be implemented in software, and the software may be stored on a recording 10 medium. At least some of the components, functions, and processes described in the exemplary embodiments of the present disclosure may be implemented as a combination of hardware and software.

1. A method for video editing based on drag and an input/output region, comprising the steps of:
receiving a handle point, a target point, a correction region including the handle point and the target point, and an output region, the output region being shape information desired to be generated using the video editing, from an original video; and
generating an initial corrected video using a diffusion model, based on the handle point, the target point, the correction region, and the output region.

2. The method of claim 1, wherein the receiving includes the steps of:
receiving the handle point and the target point to be corrected from the original video using a drag scheme;
specifying the correction region from the original video using a masking scheme; and
specifying the output region from the original video using a masking scheme.

3. The method of claim 1, wherein the diffusion model is a model based on an objective function of applying a penalty so that a difference in feature between the correction region and the output region is small.

4. The method of claim 1, further comprising:
an initial distortion correction step for correcting a distorted region occurring in a portion other than the correction region from the initial corrected video.

5. The method of claim 4, wherein the initial distortion correction step includes generating a simple reconstructed video using a mask operation to replace a distorted region occurring in the portion other than the correction region and a region corresponding to the original video with the original video, from the initial corrected video.

6. The method of claim 4, further comprising:
an additional distortion correction step for correcting a remaining distorted region after the initial distortion correction.

7. The method of claim 5, further comprising:
an additional distortion correction step for correcting a remaining distorted region in the simple reconstructed video.

8. The method of claim 6, wherein the additional distortion correction step includes the steps of:
selecting the remaining distorted region and a corresponding region in the original video to maximize a similarity between the two regions and generating a self-referential video; and
generating a final reconstructed video using a mask operation for the corresponding region of the self-referential video and a portion other than the corresponding region of the simple reconstructed video.

9. The method of claim 7, wherein the additional distortion correction step includes the steps of:
selecting the remaining distorted region and a corresponding region in the original video to maximize a similarity between the two regions and generating a self-referential video; and
generating a final reconstructed video using a mask operation for the corresponding region of the self-referential video and a portion other than the corresponding region of the simple reconstructed video.

10. An apparatus for video editing based on drag and an input/output region, comprising:
a memory configured to store instructions; and
at least one processor, wherein
the apparatus performs the processes of receiving a handle point, a target point, a correction region including the handle point and the target point, and an output region, the output region being shape information desired to be generated using the video editing, from an original video; and
generating an initial corrected video using a diffusion model, based on the handle point, the target point, the correction region, and the output region.

11. The apparatus of claim 10, wherein the process of receiving includes the processes of:
receiving the handle point and the target point to be corrected using a drag scheme from the original video;
specifying the correction region using a masking scheme from the original video; and
specifying the output region using a masking scheme from the original video.

12. The apparatus of claim 10, wherein the diffusion model is a model based on an objective function of applying a penalty so that a difference in feature between the correction region and the output region is small.

13. The apparatus of claim 10, further performing:
an initial distortion correction process for correcting a distorted region occurring in a portion other than the correction region from the initial corrected video.

14. The apparatus of claim 13, wherein the initial distortion correction process includes a process for generating a simple reconstructed video using a mask operation to replace a distorted region occurring in the portion other than the correction region and a region corresponding to the original video with the original video, from the initial corrected video.

15. The apparatus of claim 13, further performing:
an additional distortion correction process for correcting a remaining distorted region after the initial distortion correction.

16. The apparatus of claim 14, further performing:
an additional distortion correction process for correcting a remaining distorted region in the simple reconstructed video.

17. The apparatus of claim 15, wherein the additional distortion correction process includes the processes of:
selecting the remaining distorted region and a corresponding region in the original video to maximize a similarity between the two regions and generating a self-referential video; and
generating a final reconstructed video using a mask operation for the corresponding region of the self-referential video and a portion other than the corresponding region of the simple reconstructed video.

18. The apparatus of claim 16, wherein the additional distortion correction process includes the processes of:
selecting the remaining distorted region and a corresponding region in the original video to maximize a similarity between the two regions and generating a self-referential video; and
generating a final reconstructed video using a mask operation for the corresponding region of the self-referential video and a portion other than the corresponding region of the simple reconstructed video.
